(19) United States
(12) Patent Application Publication
(10) Pub. No.: US 2005/0159194 A1
(43) Pub. Date: Jul. 21, 2005

(54) Electronic device with fold out display and/or keyboard

(75) Inventors: Todd Heintz, Vancouver (CA); Jon T. Winebrenner, Richmond (CA)

Correspondence Address: Robert E. Krebs;Thelen Reid & Priest, LLP, P.O. Box 640640, San Jose, CA, 95164-0640, US

(73) Assignee: Sierra Wireless, Inc., a Canadian Corporation

(21) Appl. No.: 10/750,264

(22) Filed: Dec. 31, 2003

(51) Int. Cl. H04M 1/00

(52) U.S. Cl. 455/575.3; 455/575.1

(57) ABSTRACT

The present invention provides for a hand-held electronic device having a display screen, a number pad coupled to said display screen such that said display screen folds upward to reveal said display screen and said number pad, and a keyboard underneath said number pad such that said number pad folds out sideways to reveal said keyboard.

### FIELD OF THE INVENTION

The present invention relates to electronic devices. More particularly, the present invention relates to electronic devices with full fold out keyboard and/or display.

### BACKGROUND OF THE INVENTION

A cellular telephone is designed to give the user maximum freedom of movement while using a telephone. A cellular telephone uses radio signals to communicate between the “cell phone” and a base station, via an antenna. The served area is divided into cells, something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

In order to input information into a cellular phone, it is desirable to have a keyboard. However, with the limited size of cellular phones, it is difficult to place a keyboard and number dial pad on a cellular phone. Additionally, should a user want to play video games using the cellular phone, adding a game pad along with the number dial pad in the cellular phone is even more difficult.

U.S. Pat. No. 5,337,346 issued to Uchikura describes an electronic device with a foldable keyboard. However, the keyboard is only used for inputting data to the device while in an electronic notebook mode. Uchikura does not allow data that is entered via the keyboard to be transmitted outside the device. Currently there are about 30 billion text messages sent every month via wireless phones. This number is expected to double in the future. As mobile phones and computers converge towards unified handheld communication and computing devices, text messaging is becoming one of many ways in which text entry on handheld devices will be employed. Text entry is an integral part of the way users interact with computers in general and the Internet in particular. Simple text entry is required to query search engines, to send email or instant messages and to enter commands. The inadequacy of currently used methods for entering text is the major obstacle inhibiting the growth of a wireless web and other applications, such as, Microsoft's Pocket Word and Pocket Excel. A numeric keypad will always be a poor device for entering strings of text data. A QWERTY-style keyboard on a mobile device is needed to provide an easy to use text entry solution. Such a device will help the mobile Internet achieve its full commercial potential.

Current gaming devices with handsets that fold bring the primary display on top of the control pad area. The result is that the primary design display is not visible when the device is folded. Other gaming devices do not have folding keyboard designs along with the gaming control pad or typically map 12-key buttons into gaming buttons rather than providing separate independent gaming controls.

Thus, there exists a need for an electronic device having a number pad for telephone functions, a full keyboard for input of text entries, and/or a game control keyboard to allow a user to play video games.

### BRIEF DESCRIPTION OF THE INVENTION

The present invention provides for a hand-held electronic device having a display screen, a number pad coupled to said display screen such that said display screen folds upward to reveal said display screen and said number pad, and a keyboard underneath said number pad such that said number pad folds out sideways to reveal said keyboard.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is an illustration of a telephone in accordance with an embodiment of the present invention.

FIGS. 2A, 2B, and 2C illustrate an embodiment of the present invention in an open keyboard position.

FIGS. 3A and 3B illustrate a side view in accordance with an embodiment of the present invention.

FIG. 4 is a block diagram of a method in accordance with an embodiment of the present invention.

### DETAILED DESCRIPTION

Embodiments of the present invention are described herein in the context of an electronic device with fold out display and keyboard. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

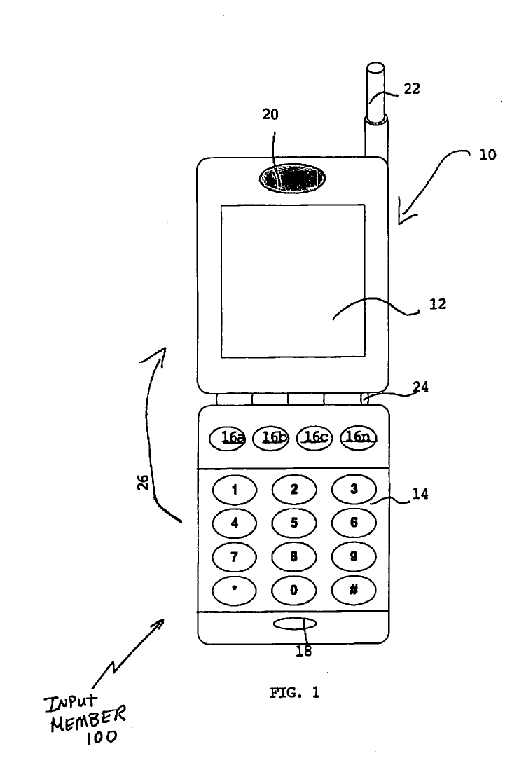

Embodiments of the present invention refer to an electronic device having a number pad for telephone functions, a full keyboard for input of text entries and/or a game control keyboard to allow a user to play games. The embodiments of the present invention may be used in cellular phones, cordless phones, and any portable telephone. Referring now to FIG. 1, an illustration of a telephone in accordance with an embodiment of the present invention. The telephone, generally numbered 10, is illustrated in a first open position with the display screen 12 folded out from the input member 100. The input member 100 consists of the numberic dial pad 14 and a keyboard. The keyboard is hidden underneath the fold-out numeric dial pad 14. The telephone 10 has a fold-out display screen 12 to provide visual output to the user. The visual output may be text, graphical information, icons, pictures, and/or videos.

Function keys 16a, 16b, 16c, 16n (where n is an integer) allow a user to control the basic functions of the telephone 10. Function keys 16a, 16b, 16c, 16n may allow a user to select options on a menu, activate various programs such as telephone and communication enabling programs. Examples of function keys may be “Talk”, “Menu”, “Cancel”, “End”, and/or arrow buttons. Although FIG. 1 illustrates four function keys, the number of function keys may vary and is not intended to be limiting. Additionally, the illustrated location of the function keys is not intended to be limiting. By way of example, the function keys may be positioned on the sides or top of the telephone 10.

The numeric dial pad 14 may be used as a traditional cellular or wire line telephone number pad. As illustrated, the number pad is a 12-key number dial pad with the numbers 0-9 on a 3×4 keypad matrix with the star symbol, zero, and pound symbol on the bottom row. The three or four letters represented on the 12-key numeric dial pad 14 on 0 and 2-9 may also be included for short text entries. The number dial pad 14 may be movably attached to the display screen 12 such that the display screen 12 may be folded upwards in the direction of arrow 26 to reveal the number dial pad 14. The number dial pad 14 may be movably attached to the display screen 12 by any means such as a hinge 24.

The telephone 10 may have a microphone 18 to accept voice data from the user. A speaker 20 provides audio output to the user. However, the number of microphones 18 and/or speakers 20 may vary in other embodiments of the present invention. For example, other embodiments of the present invention may utilize earphones and/or headsets for a “hands free” mode of operating. An antenna 22 may be used to provide for communication between the telephone 10 and a cellular telephone base station. A camera (not shown) may also be coupled to the telephone 10.

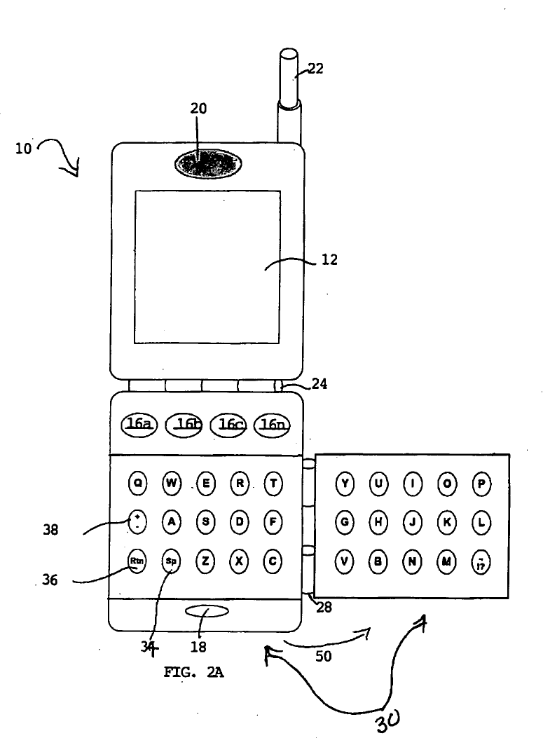

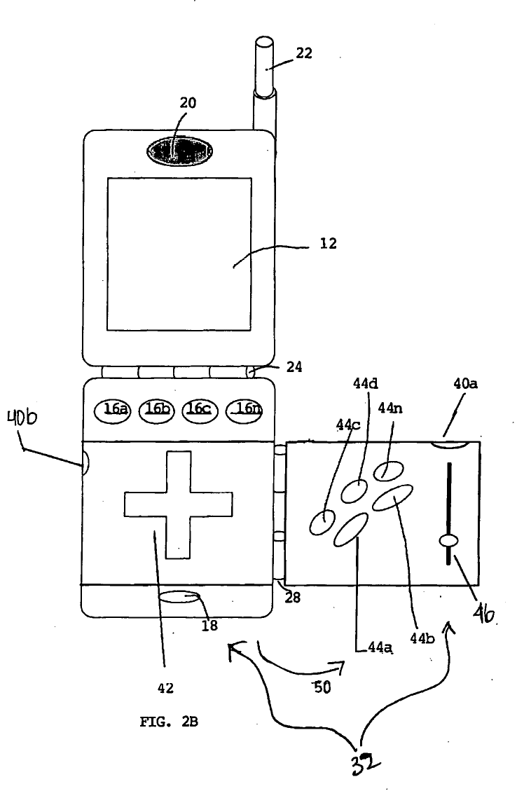

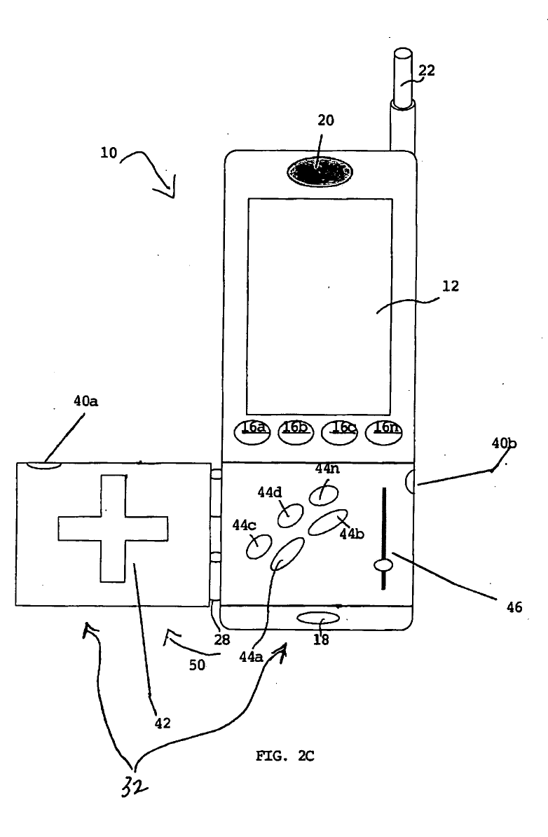

FIGS. 2A, 2B, and 2C illustrate an embodiment of the present invention in an open keyboard position. The keyboard, as illustrated in FIG. 1, was underneath the number dial pad 14. FIGS. 2A, 2B, and 2C illustrate the fold-out number dial pad 14 folded out sideways in the direction of arrow 50 to reveal the keyboard 30. Thus, an embodiment of the invention provides for a double flip telephone. The first flip, folding the display screen 12 upwards, reveals the display screen 12 and number dial pad 14. A second flip, folding the number dial pad 14 sideways, reveals the keyboard 30.

As illustrated in FIG. 2A, the keyboard may be a qwerty keyboard 30 having a space key 34, return key 36, and may have mathematical function keys 38. However, any other keyboard may be used. As illustrated in FIG. 2B, the keyboard may be a game pad keyboard 32. The game pad keyboard 32 may have various function keys such as trigger buttons 40a, 40b, a directional pad 42, programmable action buttons 44a, 44b, 44c, 44n (where n is an integer), and slider/throttle control 46. The type of function keys may vary depending on the game pad keyboard and the illustrations of the various keys is not intended to be limiting.

The number dial pad may fold out sideways either to the right as illustrated in FIG. 2B or to the left as illustrated in FIG. 2C. Thus, the direction of the fold-out of the number pad is not intended to be limiting. The number pad may be movably attached to the keyboard by any means such as a hinge 28.

As illustrated in FIG. 2C, an embodiment of the present invention may be used with only one flip. The display screen 12 and number dial pad 32 may comprise of a single unit with only the number dial pad 14 folding out to reveal the game pad keyboard 32.

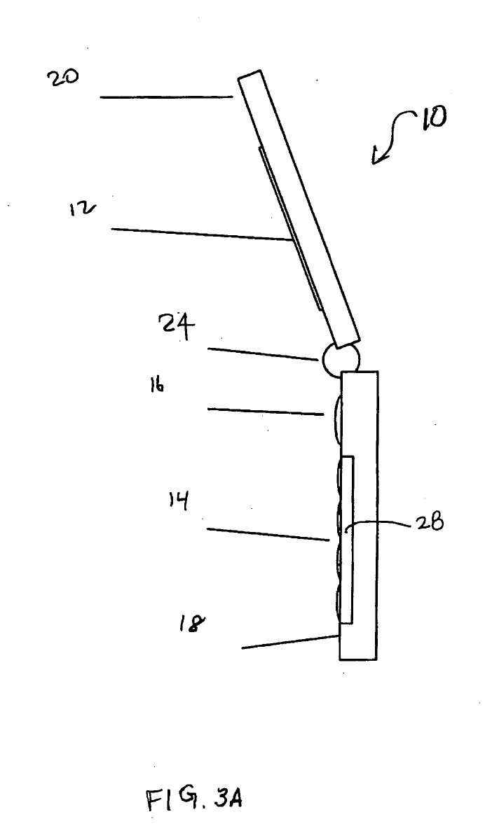

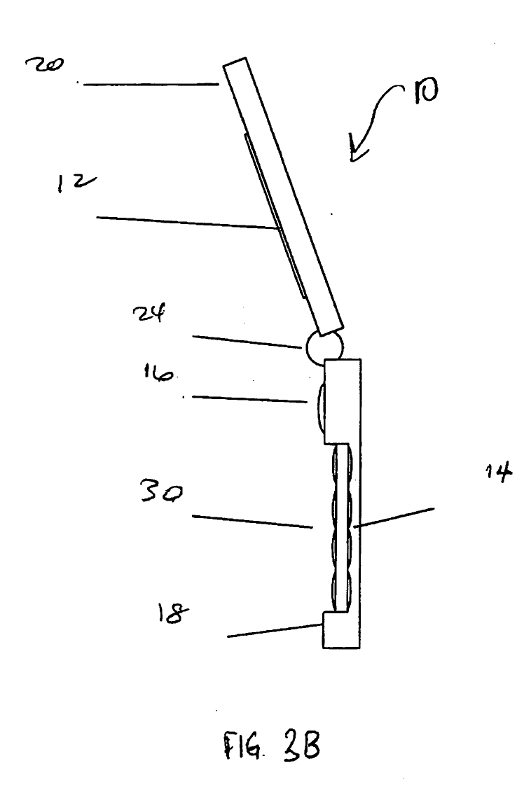

FIGS. 3A and 3B illustrate a side view in accordance with an embodiment of the present invention. FIG. 3A illustrates the side view of an embodiment of the present invention with the number pad 14 in a closed position. FIG. 3A illustrates the side view of an embodiment of the present invention with the number pad 14 in an open position such that the keyboard 30 is therefore revealed.

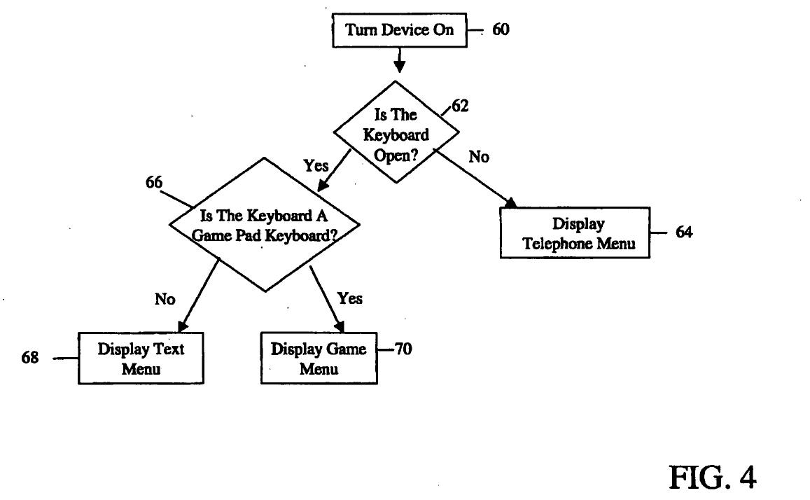

FIG. 4 is a block diagram of a method in accordance with an embodiment of the present invention. If the telephone is off, the user must turn the telephone on at 60 using an on/off function key. When the telephone is turned on or awakened from a power saving mode, the telephone determines whether the keyboard is in an open position at 62. The position of the keyboard will determine the menu that will be displayed. If the keyboard is in a closed position, a telephone menu may be displayed at 64. However, if the keyboard is in an open position, a second menu may be displayed depending on the type of keyboard at 66. If the keyboard is a game pad keyboard, then the second menu may be a game menu at 70. However, if the keyboard is a qwerty keyboard, then the second menu may be a text menu at 68 allowing a user to send electronic mail, access the internet, and perform other similar functions.

Wireless hardware and firmware capable of supporting wireless communications protocols such as CDMA, GSM, GPRS, 802.11b, Bluetooth, etc. may be included in the telephone as well as IrDa, USB, digital camera, memory expansion, and the like. Additionally, microprocessors and memory for running various software applications, wireless and web browsers, electronic mail client software, PDA software may be included in the telephone. However, to prevent obfuscation or confusion of the present invention, the hardware and software will not be further discussed as it is well known to those of ordinary skill in the art.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A hand-held electronic device, comprising:
a display screen;
a number pad coupled to said display screen such that said display screen folds upward to reveal said display screen and said number pad; and
a keyboard underneath said number pad such that said number pad folds out sideways to reveal said keyboard.

2. The device of claim 1 further comprising at least one speaker to transmit audio information.

3. The device of claim 1 further comprising at least one microphone for receiving audio data.

4. The device of claim 1 wherein said keyboard is a qwerty keyboard.

5. The device of claim 1 wherein said keyboard is a game pad keyboard.

6. The device of claim 5 wherein said game pad keyboard comprises a directional pad.

7. The device of claim 5 wherein said game pad keyboard comprises at least one programmable action button.

8. The device of claim 5 wherein said game pad keyboard comprises at least one trigger.

9. The device of claim 5 wherein said game pad keyboard comprises a slider throttle control.

10. The device of claim 1 wherein said number pad folds sideways to a right side.

11. The device of claim 1 wherein said number pad folds sideways to a left side.

12. The device of claim 1 wherein said number pad is coupled to said display screen with a hinge.

13. The device of claim 1 further comprising at least one function key that controls the basic functions of the device.

14. The device of claim 1 wherein said number pad is coupled to said keyboard with a hinge.

15. The device of claim 1 further comprising a camera.

16. A hand-held electronic device, comprising:
a display screen for displaying text and graphical information;
a number dial pad coupled to said display screen such that said display screen folds upwards to reveal said number dial pad;
a keyboard underneath said number dial pad such that said number dial pad folds out sideways to reveal said keyboard;
at least one speaker to transmit audio information; and
at least one microphone for receiving audio data.

17. The device of claim 16 wherein said keyboard is a qwerty keyboard.

18. The device of claim 16 wherein said keyboard is a game pad keyboard.

19. The device of claim 18 wherein said game pad keyboard comprises a directional pad.

20. The device of claim 18 wherein said game pad keyboard comprises at least one programmable action buttons.

21. The device of claim 18 wherein said game pad keyboard comprises at least one trigger.

22. The device of claim 18 wherein said game pad keyboard comprises a slider throttle control.

23. The device of claim 16 wherein said number dial pad folds sideways to a right side.

24. The device of claim 16 wherein said number dial pad folds sideways to a left side.

25. The device of claim 16 wherein said number dial pad is coupled to said display screen with a hinge.

26. The device of claim 16 further comprising at least one function key that controls the basic functions of the device.

27. The device of claim 16 wherein said number dial pad is coupled to said keyboard with a hinge.

28. The device of claim 16 further comprising a camera.

29. A hand-held electronic device, comprising:
a display screen for displaying text and graphical information;
a number dial pad coupled to the display screen; and
a game pad keyboard underneath said number dial pad such that said number dial pad folds out sideways to reveal said game pad keyboard.

30. The device of claim 29 further comprising at least one speaker to transmit audio information.

31. The device of claim 29 further comprising at least one microphone for receiving audio data.

32. The device of claim 29 wherein said game pad keyboard comprises a directional pad.

33. The device of claim 29 wherein said game pad keyboard comprises at least one programmable action buttons.

34. The device of claim 29 wherein said game pad keyboard comprises at least one trigger.

35. The device of claim 29 wherein said game pad keyboard comprises a slider throttle control.

36. The device of claim 29 wherein said number dial pad folds sideways to a right side.

37. The device of claim 29 wherein said number dial pad folds sideways to a left side.

38. The device of claim 29 further comprising at least one function key that controls the basic functions of the device.

39. The device of claim 29 wherein said number dial pad is coupled to said game pad keyboard with a hinge.

40. The device of claim 29 further comprising a camera.

41. A hand-held electronic device, comprising:
a display screen;
an input member coupled to said display screen, said input member comprising a number pad and a keyboard;
said input member being coupled to said display screen such that said display screen folds upward to reveal said display screen and said number pad; and
said keyboard being located underneath said number pad such that said number pad folds out sideways to reveal said keyboard.

42. The device of claim 41 further comprising at least one speaker to transmit audio information.

43. The device of claim 41 further comprising at least one microphone for receiving audio data.

44. The device of claim 41 wherein said keyboard is a qwerty keyboard.

45. The device of claim 41 wherein said keyboard is a game pad keyboard.

46. The device of claim 45 wherein said game pad keyboard comprises a directional pad.

47. The device of claim 45 wherein said game pad keyboard comprises at least one programmable action button.

48. The device of claim 45 wherein said game pad keyboard comprises at least one trigger.

49. The device of claim 45 wherein said game pad keyboard comprises a slider throttle control.

50. The device of claim 41 wherein said number pad folds sideways to a right side.

51. The device of claim 41 wherein said number pad folds sideways to a left side.

52. The device of claim 41 wherein said number pad is coupled to said display screen with a hinge.

53. The device of claim 41 further comprising at least one function key that controls the basic functions of the device.

54. The device of claim 41 wherein said number pad is coupled to said keyboard with a hinge.

55. The device of claim 41 further comprising a camera.
